(19) United States
(12) Patent Application Publication
(10) Pub. No.: US 2016/0006601 A1
(43) Pub. Date: Jan. 7, 2016

(54) CONTROLLER, COMMUNICATION SYSTEM, PATH SWITCHING METHOD AND PROGRAM

(71) Applicant: NEC CORPORATION, Tokyo (JP)

(72) Inventor: Kazuya SUZUKI, Tokyo (JP)

(73) Assignee: NEC CORPORATION, Tokyo (JP)

(21) Appl. No.: 14/769,784

(22) PCT Filed: Feb. 24, 2014
(86) PCT No.: PCT/JP2014/054324

§ 371 Date: Aug. 21, 2015

(30) Foreign Application Priority Data
Feb. 25, 2013 (JP) 2013-034982

(51) Int. Cl. H04L 12/24; H04L 12/855; H04L 12/717; H04L 12/707; H04L 12/703

(52) U.S. Cl. CPC H04L 41/0663; H04L 41/0816; H04L 45/22; H04L 45/28; H04L 45/42; H04L 47/2466

(57) ABSTRACT

A controller includes a first control information generation unit that generates the first control information that causes a forwarding apparatus being controlled to forward a packet(s) over a first path, and a second control information generation unit that generates the second control information that causes the forwarding apparatus being controlled to forward a group of packets inclusive of the packet as an object controlled by the first control information over a second path different from the first path. The controller also includes a forwarding control unit that sets the priority level of the first control information and the second control information in the forwarding apparatus being controlled so that the priority level of the second control information will be higher than that of the first control information and that, by instructing the forwarding apparatus being controlled to delete the second control information, changes over the forwarding path of at least the packet(s) matching the first control information.

### REFERENCE TO RELATED APPLICATION

This application is based upon and claims the benefit of the priority of Japanese Patent Application No. 2013-034982 filed on Feb. 25, 2013, the disclosure of which is incorporated herein in its entirety by reference thereto.

### Technical Field

This invention relates to a controller, a communication system, a path switching method and a program. More particularly, it relates to a controller, a communication system, a path switching method and a program, in which communication is accomplished by controlling a forwarding apparatus.

### BACKGROUND

In Non-Patent Literatures 1, 2, there is introduced a centralized control network termed OpenFlow. An OpenFlow switch, referred to below as ‘OFS’, and an OpenFlow controller, referred to below as ‘OFC’, in the specification of OpenFlow 1.0.0 of Non-Patent Literature 2, will hereinafter be explained.

The OFS includes a flow table(s) configured for packet lookup and forwarding and a secure channel over which to communicate with the controller. The OFC communicates with the OFS on the secure channel, using the OpenFlow protocol, and controls the flow on, for example, an API (Application Programming Interface) level.

On receipt of, for example, a first packet, the OFS searches the flow table for an entry having match conditions matching the header information of the packet. If, as a result of the search, no entry having the match conditions matching the header information of the received packet is found, the OFS sends the packet to the controller over the secure channel.

The OFC decides a forwarding path for the packet in question from the network topology information, managed by the OFC, based on the information concerning the destination of the packet and that concerning its transmission source. The OFC sets the control information (flow entry) to forward the packet along the forwarding path in the flow table of each OFS located on the so decided forwarding path.

On receipt of a succeeding packet(s) having the header information in common with the above mentioned first packet, the OFS forwards the succeeding packet(s) in accordance with the above mentioned control information (flow entry).

In the flow table of each OFS, there is stored an entry correlating the match conditions (Match Fields) for collation against the packet header, an action (Action) stating the processing to be performed on the flow, and the flow statistic information (Statistics), to one another, as shown for example in FIG. 13. The match conditions (Match Fields) operate as flow filter definition identifying a flow and may use exact values (Exact) as well as wildcards (Wild Card). As the action (Action), the content of processing to be applied to the packet matching the match conditions (Match Fields) is set by way of defining the processing to be performed on the flow. Examples of the flow statistic information, also termed activity counters, may include the numbers of active entries, packet lookups and packet matches. In terms of a flow, the examples of the flow statistic information may include the number of received packets, the number of received bytes and the time duration the flow remains active. In terms of ports, the examples of the flow statistic information may include the numbers of received packets, transmitted packets, received bytes, transmitted bytes, received and dropped packets, transmitted and dropped packets, errors in reception, errors in transmission, received frame alignment errors, received overrun errors, received CRC errors and collisions.

The OFS compares an incoming packet against the match conditions of the flow table (matching). If an entry matching the match conditions is found, the content of the action field of the entry, thus matching the packet, is applied. If conversely no matching entry has been found, the OFS sends the packet to the OFC over the secure channel. After deciding on the path for the packet in question, the

OFC transmits to the OFS a flow entry informing the OFS about forwarding path node points or units along the path thus decided on. For example, with the detection of the end of the communication, accomplished by the above mentioned flow entry, the detection of a modification or change in the network topology or with the detection of a failed OFS, as a trigger, the OFC instructs the OFS to modify or delete the flow entry. The OFS adds, modifies or deletes the flow entry in accordance with these instructions from the OFC.

Certain defined fields of the packet header are used for collation against the match conditions of the switch flow table. The information used for matching is shown in an Ethernet (registered trademark)/TCP/IP packet header, shown in FIG. 14, and may be enumerated by MAC DA (Media Access Control Destination Address), MAC SA (MAC Source Address), Ethernet type (TPID; Tag Protocol iDentifier), VLAN ID (Virtual Local Area Network ID), VLAN TYPE (priority level), IP SA (Internet Protocol Source Address), IP DA (IP Destination Address), IP protocols, Source Port (TCP/UDP source port or ICMP (Internet Control Message Protocol) Type, Destination Port (TCP/ UDP destination port or ICMP Code)).

FIG. 15 shows representative action names supported by the OFS and the contents of the actions. Output is an action to output a packet on a specified port (interface). SET_VLAN_VID to SET_TP_DST denote actions that correct fields of the packet header. Such packet that matches a flow entry where no action is stated is dropped.

By the way, the OFS has the function of forwarding a packet not only to physical ports but also to virtual ports shown in FIG. 16, in which there are shown examples of reserved virtual ports in the specification of the OpenFlow 1.0.0. IN_PORT is a virtual port used in sending a packet out on its ingress port. NORMAL is a virtual port used in processing using a pre-existing forwarding path supported by the switch. FLOOD is a virtual port used in forwarding a packet on all ports in the communication enabled state (in the forwarding state) except the packet incoming port. ALL is a virtual port used in forwarding a packet on ports other than the packet incoming port. CONTROLLER is a virtual port used in encapsulating the packet and transmitting the so encapsulated packet to the controller. LOCAL is a virtual port on which the packet is transmitted to the switch's local network stacks.

FIG. 17 shows representative control messages exchanged over the secure channel between the OFS and the OFC. Flow-mod is a message used for the OFC to add, modify or delete a flow entry in the OFS. Packet-In is a message sent from the OFS to the OFC in sending a packet not matching a flow entry. Packet-Out is a message sent from the OFC to the OFS to output a packet generated by the OFC on an optional port of the OFS. Port-Status is a message sent from the OFS to the OFC to inform that the port state has changed. If, for example, a link connecting to a port has failed, a notification is made to the effect that the link is in a down state. Flow-Removed is a message sent from the switch to the controller to inform the controller that the flow entry has been out of use for a preset time and timed out so that it is to be deleted from the flow table of the OFS.

The above described specification of OpenFlow 1.0.0 has been extended in Non-Patent Literature 3 so as to enable handling a plurality of flow tables. In the specification of OpenFlow 1.1.0 of Non-Patent Literature 3, a defined table, here a flow table #0, is initially referenced. In case a packet has matched an entry in the flow table, which table is to be next referenced can be designated.

This extension renders it possible to exercise control in a manner more flexible than has hitherto been possible.

Patent Literature 1 shows a communication system exploiting the OpenFlow described above. There is thus shown a configuration in which an alternate path(s) is calculated beforehand, and an alternate flow entry or entries is set in a communication device equivalent to the above mentioned OFS. If a malfunction or congestion has occurred in a network, the OFS deletes such flow entry or entries where a drop (discard) action has been set, thereby changing over the path.

### CITATION LIST

### Patent Literature

Patent Literature 1: JP Patent Kokai Publication No. 2012-49674A

### Non Patent Literature

Non-Patent Literature 1: Nick McKeown and seven others, “OpenFlow: Enabling Innovation in Campus Networks”, [online], [retrieved on January 9, Heisei25 (2013), Internet <URL:http://www.openflow.org/documents/openflow-wp-latest.pdf>

Non-Patent Literature 2: “OpenFlow Switch Specification” Version 1.0.0 (Wire Protocol 0x01), [online], [retrieved on February 14, Heisei25 (2013), Internet <URL:http//www.openflow.org/documents/openflow-spec-v1.0.0.pdf>

Non-Patent Literature 3: “OpenFlow Switch Specification” Version 1.1.0 (Wire Protocol 0x02), [online], [retrieved on February 14, Heisei25 (2013), Internet <URL:http://www.openflow.org/documents/openflow-spec-v1.1.0.pdf>

### SUMMARY

### Technical Problem

The following analysis is given by the present invention. As set out in Patent Literature 1, the centralized control network, represented by the OpenFlow, suffers a drawback that it takes much time to cope with failures or congestion that may occur in the network (see paragraphs 0006 to 0008 of Patent Literature 1).

In this respect, it is possible with the method of Patent Literature 1 to change over a path at a high speed. It is however necessary to impart to a path control information processing unit of a switch an additional function of searching a flow table for an entry instructing forwarding a packet on a failed port as well as another additional function of deleting, if such entry should exist, a processing ‘drop’ of an alternative flow entry group matching the match condition of such entry (see paragraphs 0064 and 0065 of Patent Literature 1).

It is an object of the present invention to provide a controller, a communication system, a path switching method and a program, according to which it is possible to contribute to increasing the speed of path switching in a centralized control network without it being necessary to add any specific functions to a switch.

### Solution to Problem

In a first aspect, there is provided a controller comprising a first control information generation unit that generates the first control information that causes a forwarding apparatus being controlled to forward a packet(s) over a first path, a second control information generation unit that generates the second control information that causes the forwarding apparatus being controlled to forward a group of packets, inclusive of the packet as an object controlled by the first control information, over a second path different from the first path, and a forwarding control unit. The forwarding control unit sets the priority level of the first control information and that of the second control information in the forwarding apparatus being controlled so that the priority level of the second control information will be higher than that of the first control information and, by instructing the forwarding apparatus being controlled to delete the second control information, changes over the forwarding path of at least the packet(s) matching the first control information.

In a second aspect, there is provided a communication system including a forwarding apparatus configured to process a received packet in accordance with the control information set from outside, and also including the above mentioned controller.

In a third aspect, there is provided a method for path switching comprising the steps of generating the first control information that causes a forwarding apparatus being controlled to forward a packet(s) over a first path, generating the second control information that causes the forwarding apparatus being controlled to forward a group of packets, inclusive of the packet as an object controlled by the first control information, over a second path different from the first path, setting the priority level of the first control information and that of the second control information in the forwarding apparatus being controlled so that the priority level of the second control information will be higher than that of the first control information, and instructing the forwarding apparatus being controlled to delete the second control information so as to change over the forwarding path of at least the packet(s) matching the first control information. The present method is bound up to a particular machine which is a controller configured for controlling a forwarding apparatus disposed on a centralized control network.

In a fourth aspect, there is provided a program that causes a computer configured to control a forwarding apparatus to perform a processing of generating the first control information that causes the forwarding apparatus being controlled to forward a packet(s) over a first path, a processing of generating the second control information that causes the forwarding apparatus being controlled to forward a group of packets, inclusive of the packet as an object controlled by the first control information, over a second path different from the first path, a processing of setting the priority level of the first control information and that of the second control information in the forwarding apparatus being controlled so that the priority level of the second control information will be higher than that of the first control information, and a processing of instructing the forwarding apparatus being controlled to delete the second control information to change over the forwarding path of at least the packet(s) matching the first control information. By the way, the present program can be recorded on a computer-readable (non-transient) recording medium. That is, the present invention can be implemented as a computer program product.

### Advantageous Effects of Invention

According to the present invention, it is possible to contribute to high speed path switching of a centralized control network without it being necessary to add any specific functions to a switch.

### BRIEF DESCRIPTION OF DRAWINGS

FIG. 1 is a schematic view showing a configuration of an exemplary embodiment of the present invention.

FIG. 2 is a schematic view showing an operation of the exemplary embodiment of the present invention.

FIG. 3 is a block diagram showing a configuration of a controller of an exemplary embodiment 1 according to the present invention.

FIG. 4 is a tabular view showing an example of the topological information stored by the controller of the exemplary embodiment 1 according to the present invention.

FIG. 5 is a tabular view showing an example of the path information stored by the controller of the exemplary embodiment 1 according to the present invention.

FIG. 6 is a schematic view showing a topological configuration among switches corresponding to the topological information of FIG. 4.

FIG. 7 is a schematic view showing results of path calculations by a controller of the exemplary embodiment 1 according to the present invention.

FIG. 8 is a flowchart showing the operation of the controller of the exemplary embodiment 1 according to the present invention (processing of setting the first control information).

FIG. 9 is a flowchart showing the operation of the controller of the exemplary embodiment 1 according to the present invention (processing of setting the second control information).

FIG. 10 is a tabular view showing example flow entries set in a first table of the switch of the exemplary embodiment 1 according to the present invention.

FIG. 11 is a tabular view showing example flow entries set in two second tables of the switch of the exemplary embodiment 1 according to the present invention.

FIG. 12 is a flowchart showing an operation of the controller of the exemplary embodiment 1 according to the present invention (processing of path switching).

FIG. 13 is a schematic view showing a flow table of an OFS, shown as a background technique.

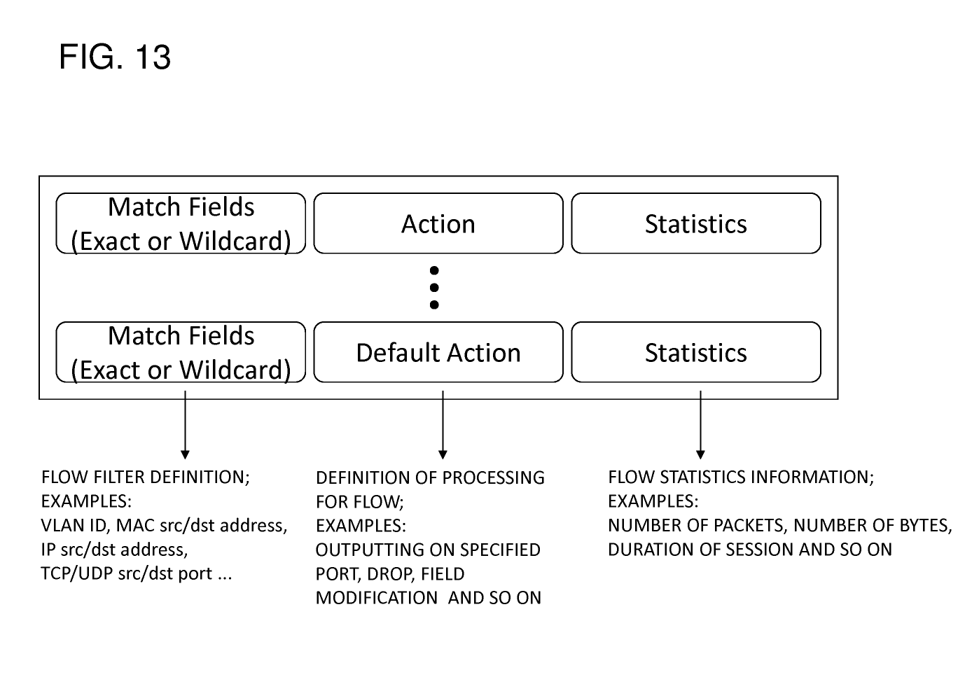

FIG. 14 is a tabular view for illustrating packet header items referred to by the OFS, shown as a background technique.

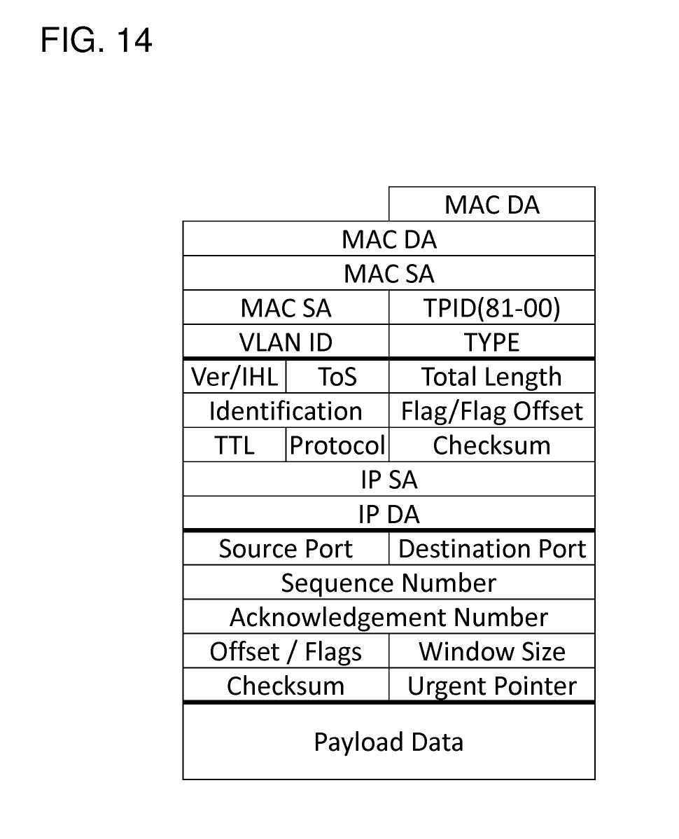

FIG. 15 is a tabular view showing actions the OFS exercises on an incoming packet, shown as a background technique.

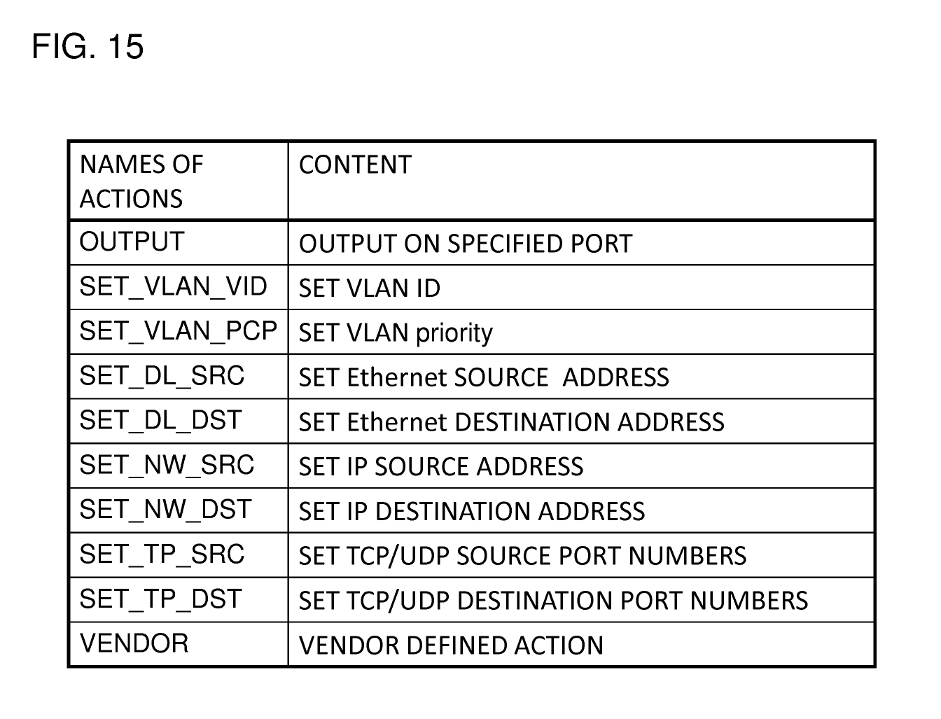

FIG. 16 is a tabular view for illustrating virtual ports supported by the OFS, shown as a background technique.

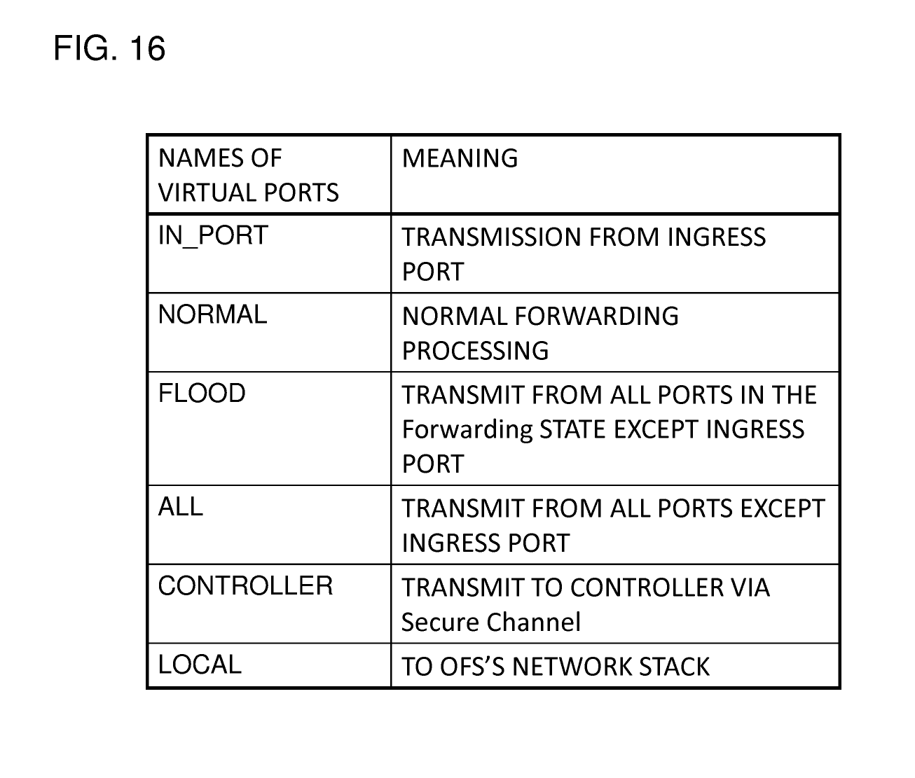

FIG. 17 is a tabular view for illustrating control messages of an OpenFlow protocol, shown as a background technique.

### DESCRIPTION OF EMBODIMENTS

A preferred exemplary embodiment of the present invention will now be summarized with reference to the drawings. It is noted that symbols are entered in the summary merely as examples to assist in understanding and are not intended to limit the present invention to the mode illustrated.

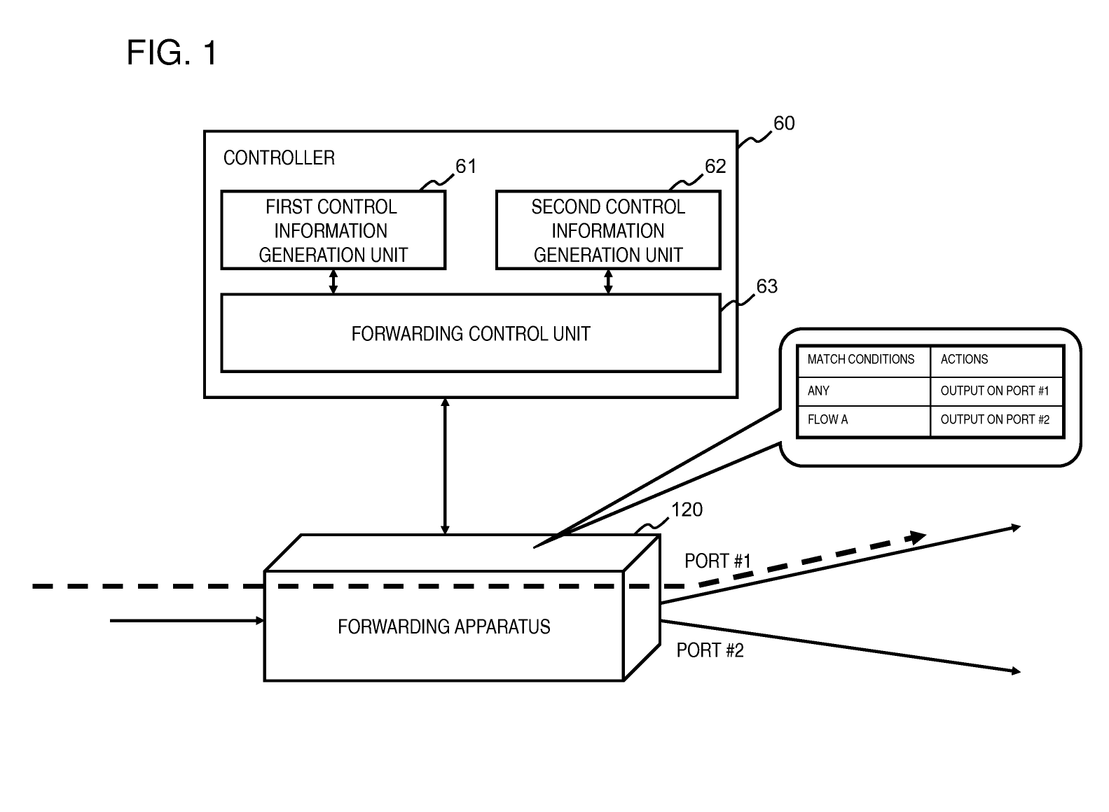

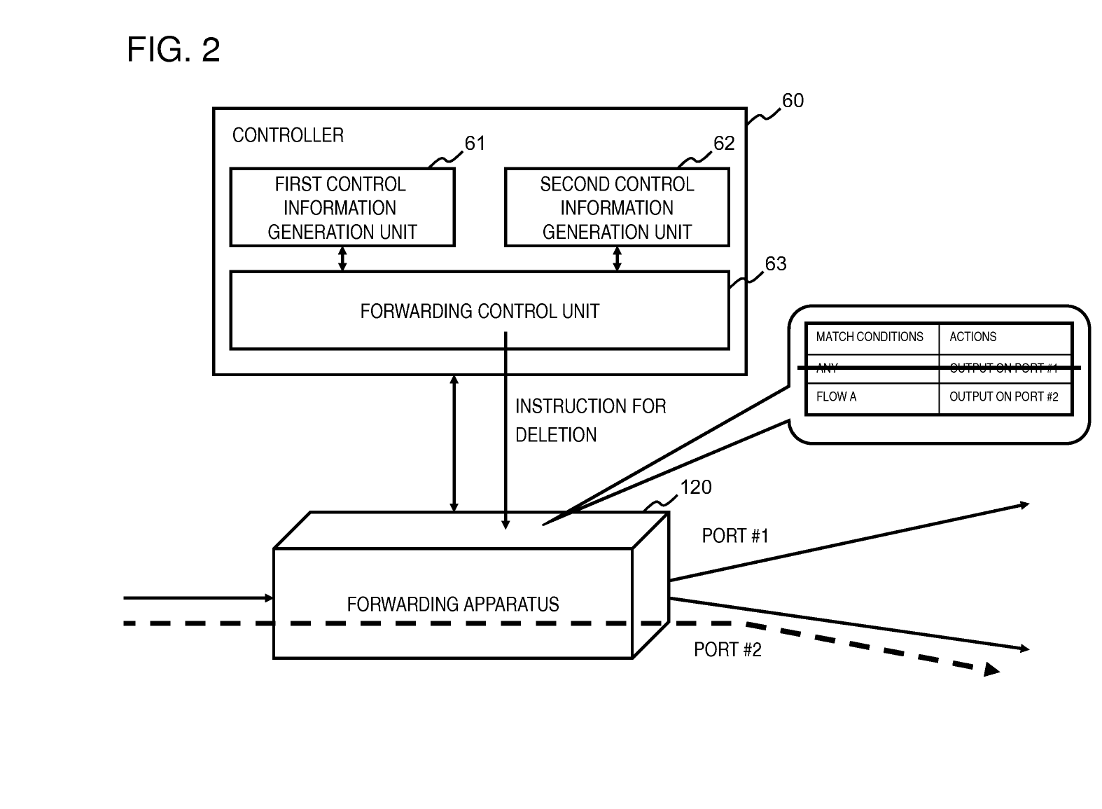

In its preferred exemplary embodiment, the present invention may be implemented by a controller 60 including a first control information generation unit 61, a second control information generation unit 62 and a forwarding control unit 63, as shown in FIG. 1. The first control information generation unit 61 generates the first control information that causes a forwarding apparatus that is under control 120 to forward a packet over a first path. The second control information generation unit 62 generates the second control information that causes the forwarding apparatus that is under control 120 to forward a group of packets, inclusive of the packet as an object controlled by the first control information, over a second path different from the above mentioned first path. Specifically, the forwarding control unit 63 sets the priority level for the first control information and that of the second control information in the forwarding apparatus that is under control 120 so that the priority level of the second control information will be higher than that of the first control information. By instructing the forwarding apparatus under control to delete the above mentioned second control information, the forwarding control unit 63 changes over the forwarding path for at least the packet matching the first control information (see FIG. 2).

With the above described arrangement, should a port of the forwarding apparatus 120 have failed, the packet forwarding path can simply be changed over by instructing deletion of the second control information stating that the port in question is to act as a forwarding path point or unit, even though the port now failed. Such port failure can be detected by e.g., receipt of the above mentioned ‘Port-Status’ message.

By the way, the control information for forwarding a packet to the destination is preferably set beforehand in a forwarding apparatus the path has been changed over to. The forwarding apparatus, the path has been changed over to, may also send the above mentioned Packet-In message to the controller 60, which then re-calculates a path so as to set the control information.

### Exemplary Embodiment 1

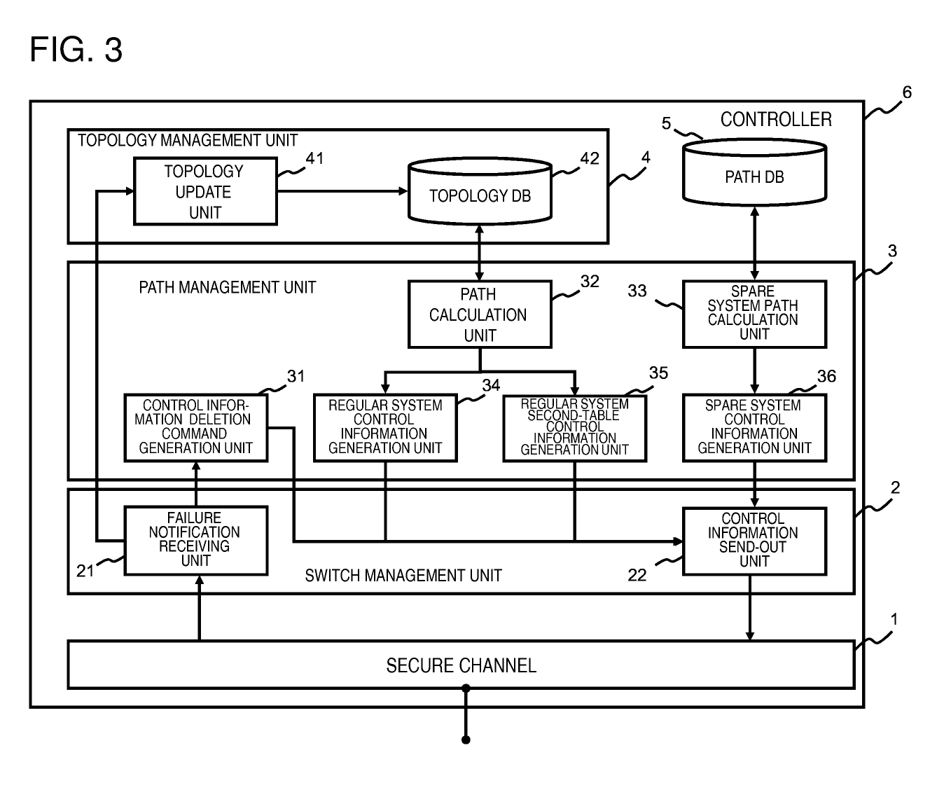

Next, the exemplary embodiment 1 according to the present invention will be described in detail with reference to the drawings. FIG. 3 shows a configuration of a controller 6 of the exemplary embodiment 1.

Referring to FIG. 3, there is shown a configuration including a secure channel 1, over which to communicate with respective switches in a network, a switch management unit 2, a path management unit 3, a topology management unit 4 and a path database 5.

The switch management unit 2 includes a failure notification receiving unit 21 and a control information send-out unit 22. On receipt of a failure notification from a switch over the secure channel 1, the failure notification receiving unit 21 informs a control information deletion command generation unit 31 of the path management unit 3 about the content of the failure. The control information send-out unit 22 sends out the control information, transmitted thereto from any one of a control information deletion command generation unit 31, a regular system control information generation unit 34, a regular system second-table control information generation unit 35 and a spare system control information generation unit 36, to each switch over the secure channel 1.

The path management unit 3 includes a path calculation unit 32 and a spare system path calculation unit 33, in addition to the control information deletion command generation unit 31, regular system control information generation unit 34, regular system second-table control information generation unit 35 and the spare system control information generation unit 36.

The control information deletion command generation unit 31 analyzes the failure notification, transmitted thereto from the failure notification receiving unit 21, and generates a control message instructing deletion of the control information of a relevant second table of a relevant switch (second control information). The control information deletion command generation unit sends the control message generated to the control information send-out unit 22.

The path calculation unit 32 calculates a path used at the time of regular or routine operation (second path), based on the topological information stored in a topology database (topology DB) 42, and sends the results calculated to the regular system control information generation unit 34 and to the regular system second-table control information generation unit 35.

The spare system path calculation unit 33 calculates a path, used at the time of failure of each switch port (first path), based on the topological information stored in the topology DB 42, and sends the results calculated to the spare system control information generation unit 36.

The regular system control information generation unit 34 generates the control information to be stored in a first table of the switch, based on results of the path calculations transmitted thereto from the path calculation unit 32. The regular system control information generation unit sends the so generated control information to the control information send-out unit 22.

The regular system second-table control information generation unit 35 generates the high priority regular system control information (second control information) which is to be stored in the switch table, based on results of the path calculations transmitted thereto from the path calculation unit 32. The regular system second-table control information generation unit sends the so generated second control information to the control information send-out unit 22.

The spare system control information generation unit 36 generates the spare system control information (first control information) to be stored in a switch table, based on the results of the path calculations transmitted from the spare system path calculation unit 33. The spare system control information generation unit sends the so generated first control information to the control information send-out unit 22.

The topology management unit 4 includes a topology update unit 41 and a topology DB 42. The topology update unit 41 updates the information of the topology DB 42 based on a failure notification transmitted thereto from the failure notification receiving unit 21

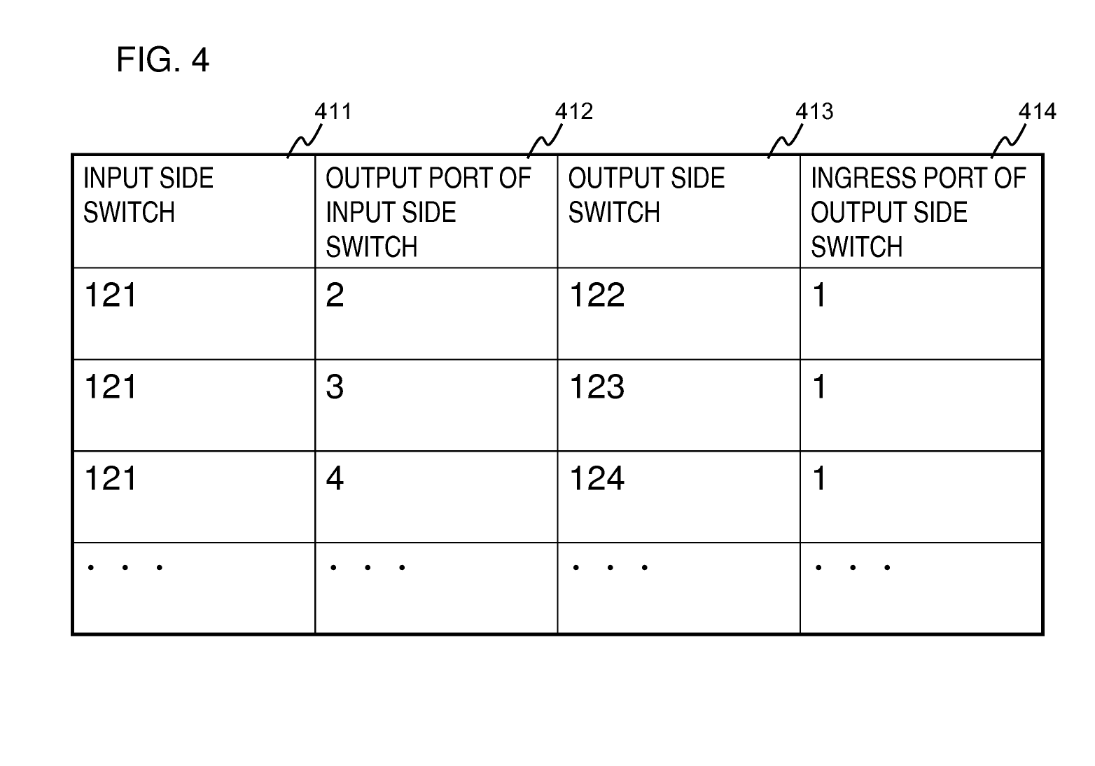

The topology DB 42 is storing the information on interconnections among switches of a network managed by the controller 6. FIG. 4 depicts an example of the topological information as stored in the topology DB 42. The example of FIG. 4 shows entries in each of which an ID 411 of an input side switch, an output side port number 412 of the input side switch, an ID 413 of an output side switch and an ingress port number 414 of the output side switch are correlated one to another.

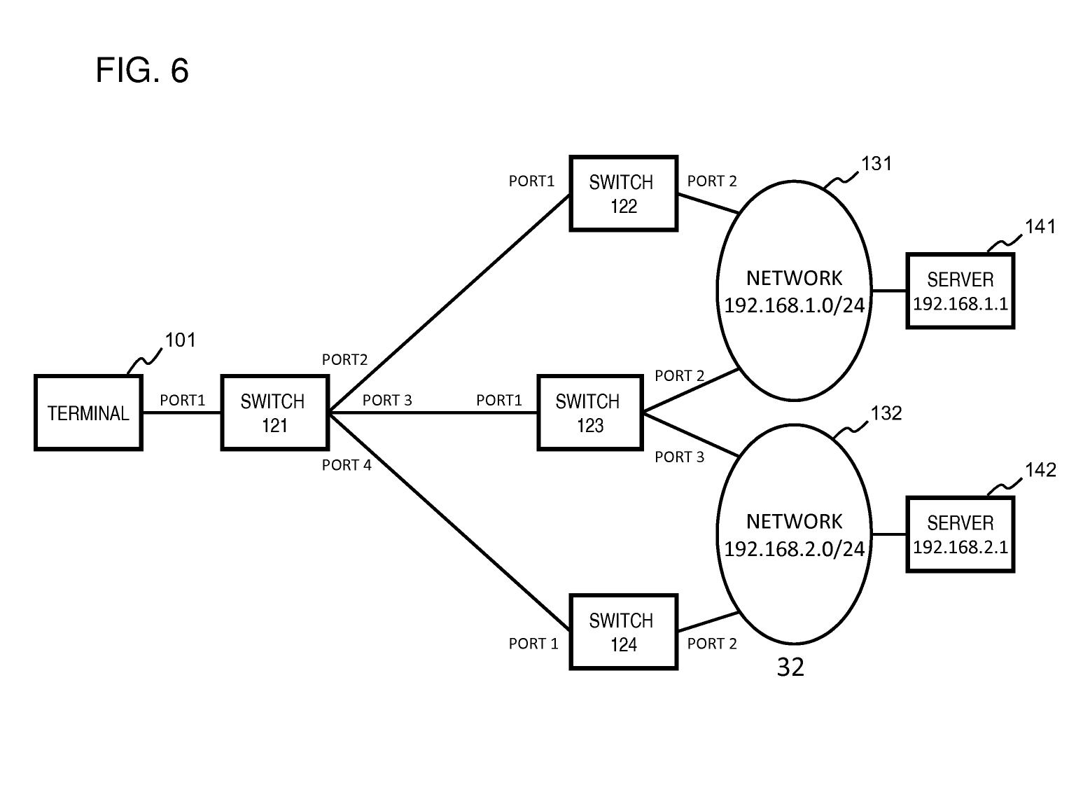

For example, a topmost entry of FIG. 4 indicates that there exists a link extending from the second port of the switch with the ID 121 to the first port of the switch with the ID 122. Similarly, second and third entries from the topmost entry in FIG. 4 indicate that there exist links extending from the third and fourth ports of the switch with the ID of 121 to the first ports of switches with the IDs 123, 124. Using these entries, the relationship of interconnections among the switches 121 to 124 can be represented in a manner shown in FIG. 6.

By the way, the above described topological information can be collected by the controller 6 instructing a switch to send out e.g., an LLDP (Link Layer Discovery Protocol) packet with the use of the above mentioned Packet-Out message and receiving the above mentioned Packet-In message from a relevant switch. However, a network topology, provided by some other method, may, of course, be used.

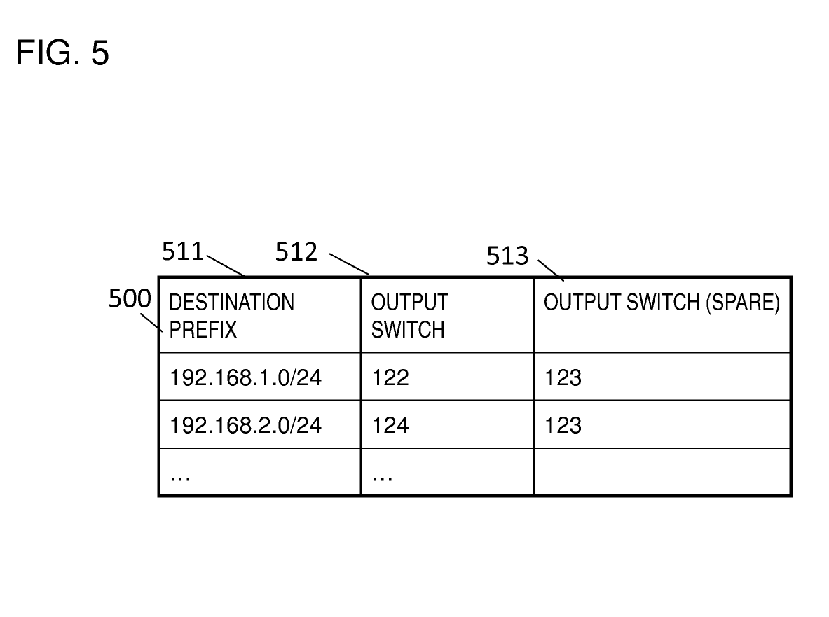

The path database (path DB) 5 is storing the path information calculated by the path calculation unit 32 and the spare system path calculation unit 33. FIG. 5 shows an example of the path information stored in the path DB 5. In the example of FIG. 5, there are shown entries in which a destination prefix 511 is correlated with an output switch ID 512 and with a spare output switch ID 513.

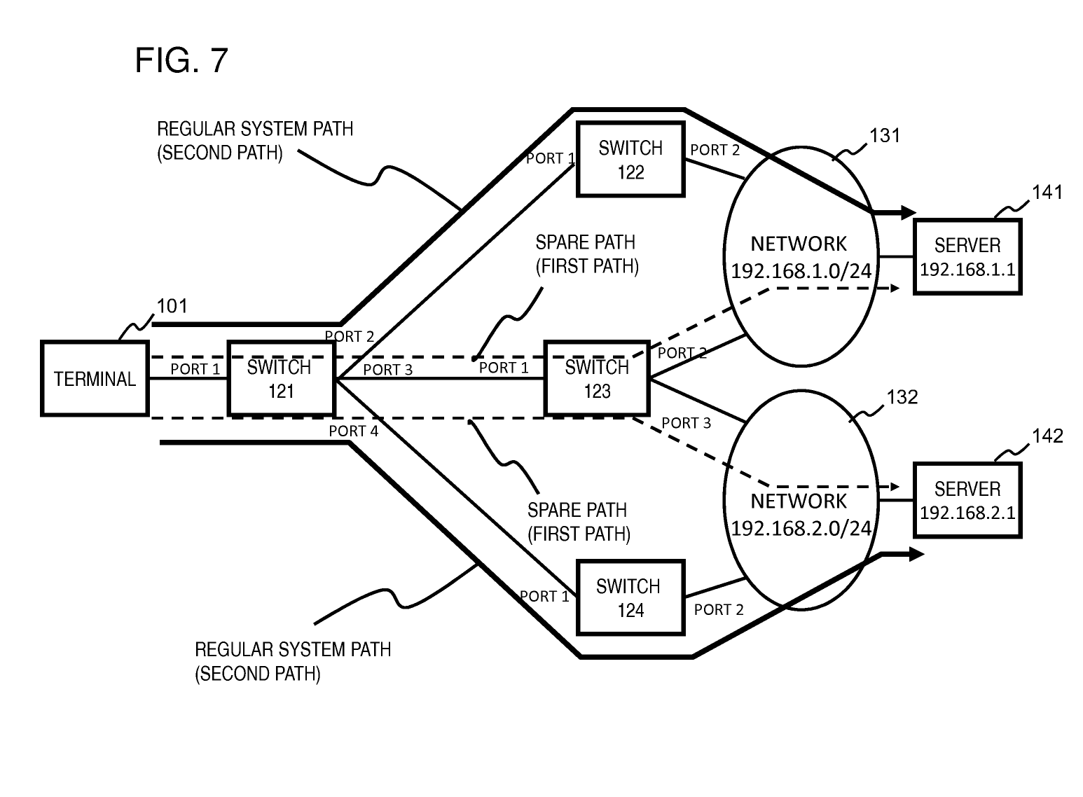

For example, the topmost entry of FIG. 5 shows that an output switch connected to a destination prefix 192.168.1.0/24 is the switch with the ID of 122 and that the spare output switch is a switch with the ID of 123. The second topmost entry shows that an output switch connected to a destination prefix 192.168.2.0/24 is a switch with the ID of 124 and that the spare output switch is a switch with the ID of 123. FIG. 7 shows the path information of FIG. 5 superimposed on FIG. 6. In the explanation to follow, it is assumed that calculations of the regular system path (second path) and the spare path (first path) have already been made as shown in FIG. 7.

By the way, in the above described configuration of the controller 6, the regular system second-table control information generation unit 35 is equivalent to the above described second control information generation unit, and the spare system control information generation unit 36 to the above described first control information generation unit.

It should be noted that respective units (processing means) of the controller 6, shown in FIG. 3, can be implemented by a computer program that causes a computer, making up the controller 6, to perform the above described processing operations using the computer hardware resources.

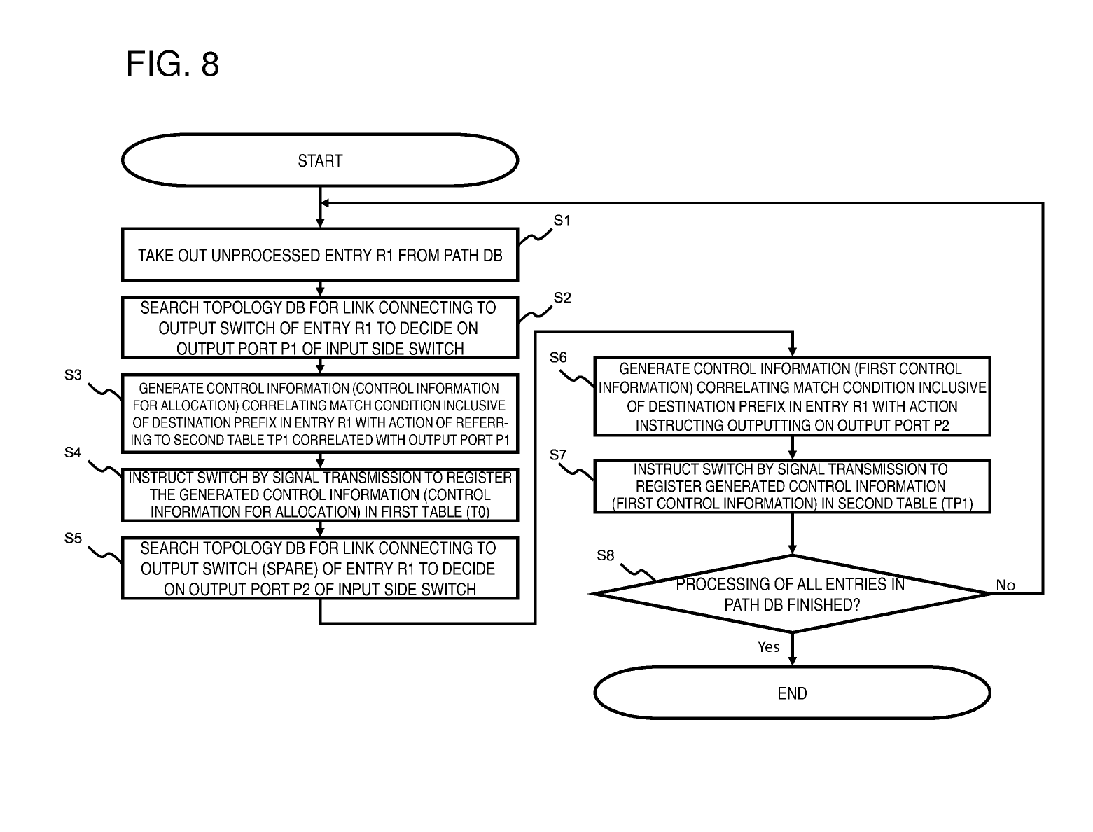

The operation of the subject exemplary embodiment will now be described in detail with reference to the drawings. Initially, the processing of setting the control information, carried out by the controller of the exemplary embodiment 1 of the present invention from one path to another, will be explained. FIG. 8 depicts a flowchart showing the progress of the control information according to the exemplary embodiment 1 of the present invention (control information setting processing 1). In the explanation to follow, it is presupposed that a switch can store a plurality of control information storage tables, as taught in Non-Patent Literature 3, and that, on receipt of a packet, the switch necessarily refers to a first table, referred to below as ‘a table T0’, in order to decide on the next following operations. It is also presupposed that the switch additionally includes a set of second tables corresponding to its port numbers. For example, there are provided an n-number of second tables, referred to below as ‘tables T1 to Tn’, having table numbers of from 1 to n, respectively corresponding to the first to the n′th ports.

Referring to FIG. 8, the path calculation unit 32 initially takes out an unprocessed entry R1 from the path DB 5 (step S1). For example, a topmost entry is taken out from the path entries of FIG. 5.

The path calculation unit 32 then searches the topology DB 42 for a link connecting to an output switch in the entry R1 to decide on an output port P1 of the input side switch (step S2). For example, from the topological information of FIG. 4, the topmost entry corresponding to the link connecting to the output switch 122 in the entry R1 is taken out. In this case, the output port P1 of the input side switch is the second port (port 2) of the switch 121 of FIG. 7.

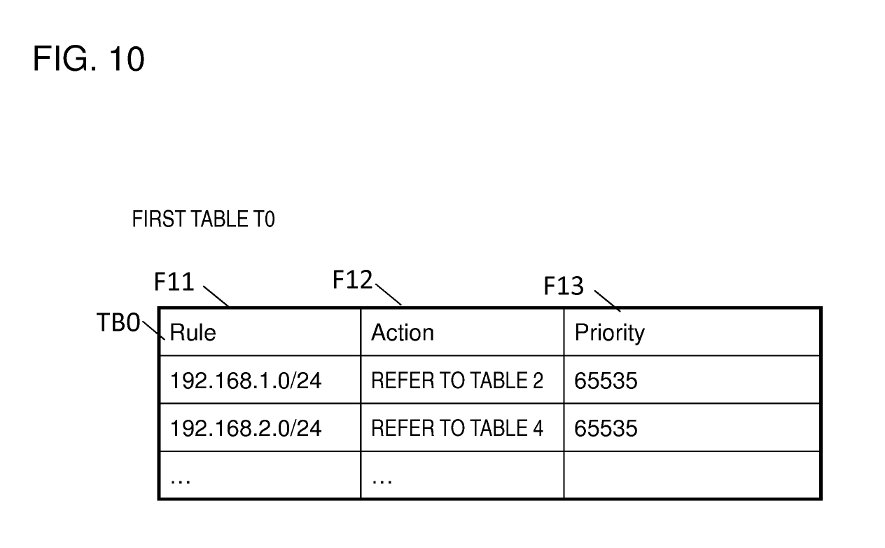

The regular system control information generation unit 34 then formulates the control information which correlates a match condition including a destination prefix in the entry R1 with an action stating that a second table corresponding to the output port P1 is to be referred to (step S3). This control information is the control information for allocation. For the switch 121 of FIG. 7, for example, the control information shown topmost in FIG. 10 that correlates the match information including the destination prefix of FIG. 5 with referencing a table T2 correlated with the second port (port 2) is formulated. It should be noted that, in the explanation of the subject exemplary embodiment, the output port number P1 of the input side switch is in one-to-one correspondence to the table number. It is however also possible to provide a table correlating the port numbers and the table numbers to each other and to look up this table to decide the table to be referred to.

The control information send-out unit 22 then transmits the control information (control information for allocation) to the switch 121, as well as instructing the switch to register the control information in the first table T0 (step S4). Here, the control information with an action stating that, if the switch 121 has received a packet matching the match condition 192.168.1.0/24, the table T2 is to be referred to, is set (see the topmost entry of FIG. 10).

The spare system path calculation unit 33 then searches the topology DB 42 for a link connecting to the output switch (spare switch) in the entry taken out in the step S1, so as to decide on an output port P2 of the input side switch (step S5). For example, the second topmost entry, corresponding to the link connecting to the output switch (spare switch) 123 in the entry R1, is taken out from the topological information of FIG. 4. In this case, the output port P2 of the input side switch is a third port (port 3) of the switch 121 of FIG. 7.

The spare system path control information generation unit generates the control information (first control information) correlating the match condition including the destination prefix in the entry R1 with an action stating that outputting is on the output port P2 (step S6).

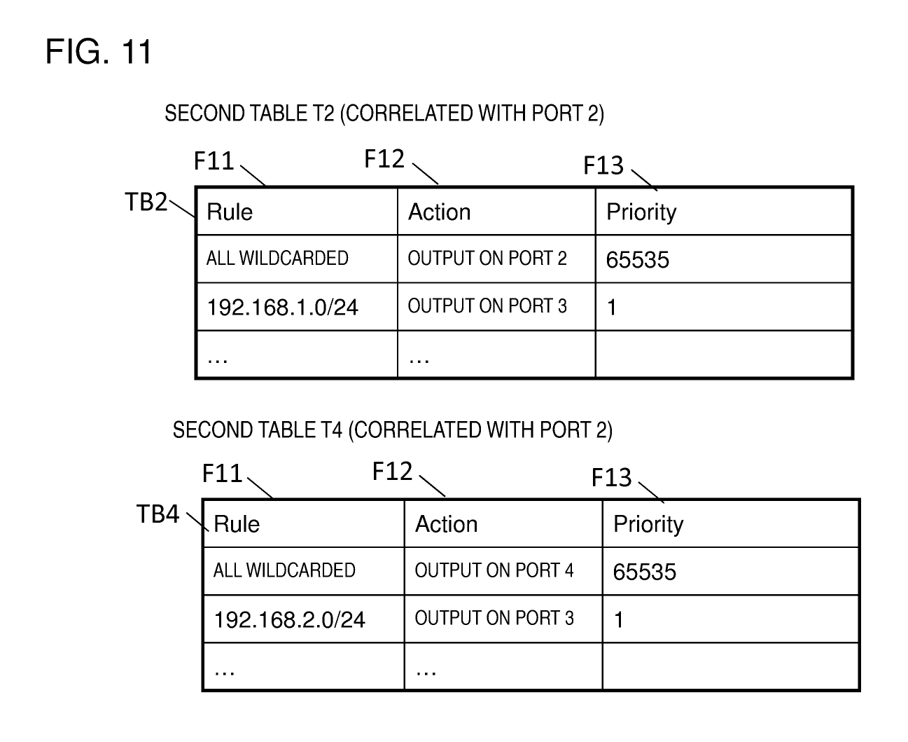

The control information send-out unit 22 transmits the control information (first control information) to the switch 121, as well as instructing the switch to register the control information in the second table T2 (step S7). Here, the control information (first control information) having an action stating that, if the switch 21 has received a packet matching the match condition 192.168.1.0/24, the packet is to be output on the port P2, that is, on the port 3, is set (see the second topmost entry of an upper side table of FIG. 11). By the way, for this control information (first control information), a priority level lower than that of the second control information, explained later, is set (see the Priority of the second topmost entry of the upper side table of FIG. 11=1). Therefore, if the switch 121 has received a packet addressed to a server 141 having a destination IP address of 192.168.1.1, and there is the second control information having a higher priority level, an action of the second control information is applied.

The path calculation unit 32 then checks to see if the total of the entries in the path DB 5 has been processed (step S8). If the result indicates that the total of the entries has not been processed, processing reverts to the step S1 and, if otherwise, the sequence of operations is brought to a close. If, for example, the second topmost entry of FIG. 5 has not been processed, the above described processing is carried out. Thus, the processing of setting the control information (control information for allocation) in the first table T0 in the switch 121 (see the second topmost entry of FIG. 10) and the processing of setting the control information (first control information) in a second Table T4 of the switch 121 (see the second topmost entry in the lower side table of FIG. 11) are carried out.

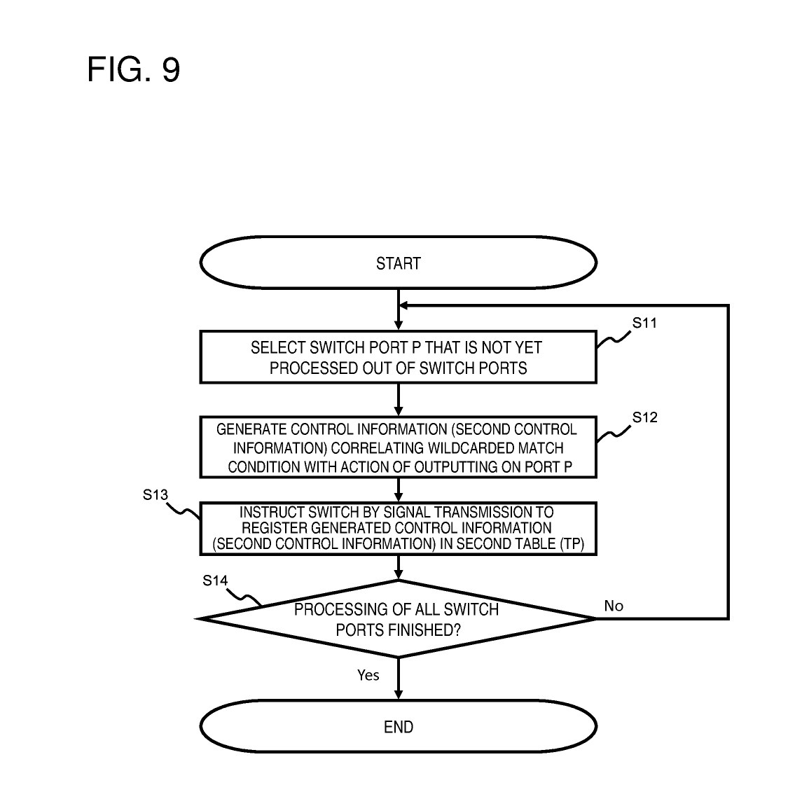

The processing of setting the control information, carried out by the controller of the exemplary embodiment 1 from one output port to another, will now be explained. FIG. 9 depicts a flowchart showing the operation of the controller of the exemplary embodiment 1 according to the present invention (control information setting processing 2). Referring to FIG. 9, the regular system second-table control information generation unit 35 selects an unprocessed output port P out of the output ports of the switch S being processed (step S11). If, for example, ports P2 and P4 out of the ports of the switch 121 of FIG. 7 are unprocessed, the port 2 is selected.

The regular system second-table control information generation unit 35 then generates, in a step S12, the control information correlating the match conditions, in which the total of fields is wildcarded, with an action stating that outputting is on the relevant port P (second control information).

The control information send-out unit 22 transmits the control information (second control information) to the switch 121, as well as instructing the switch to register the control information in the second table TP correlated with the selected port P (step S13). If, for example, the port 2 of the switch 121 is selected in the step S11, the control information including an action stating that all packets are to be output on the port 2 is set in the switch 121, see the topmost entry of an upper side table of FIG. 11. For this control information (second control information), a priority level higher than that of the above mentioned first control information is set, see Priority of the topmost entry of the upper side table of FIG. 11=65535. Therefore, if, for example, the switch 121 has received a packet addressed to the server 141, having a destination IP address of 192.168.1.1, and there is the second control information, the action of the second control information is applied.

The regular system second-table control information generation unit 35 then checks to see if the output port(s) of the switch S being processed has been processed (step S14). If the output port(s) of the switch S being processed has not been processed, processing reverts to the step S11. If otherwise, the sequence of the processing operations is brought to a close. If the processing of the port 4 of the switch 121 of FIG. 7 has not been completed, the above described processing is carried out. Thus, the processing of setting the control information (second control information) in the second table T4 correlated with the port 4 of the switch 121 is carried out, see the topmost entry of the lower side table of FIG. 11.

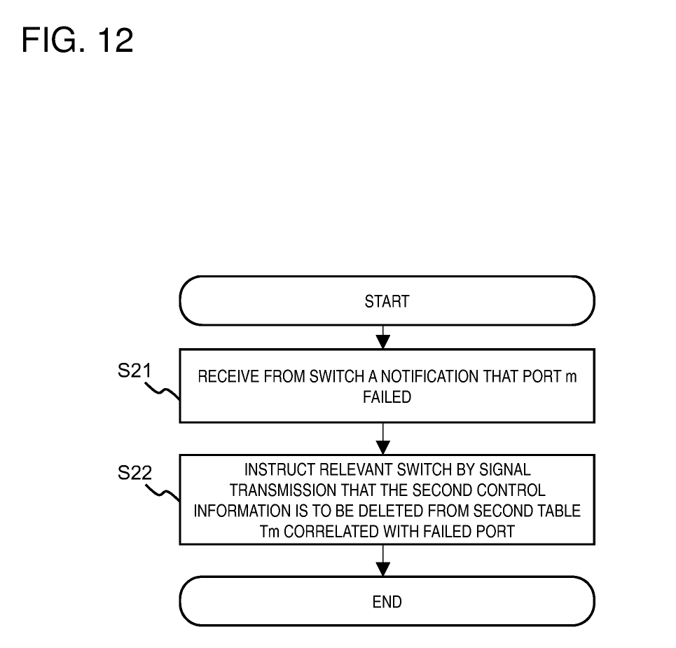

The operation when a port down notification has been made from a switch by way of a failure notification will now be explained. It is premised that the setting of the control information has been completed as shown in FIG. 10 and FIG. 11. FIG. 12 depicts a flowchart showing the operation of the controller of the exemplary embodiment 1 according to the present invention (processing of path switching).

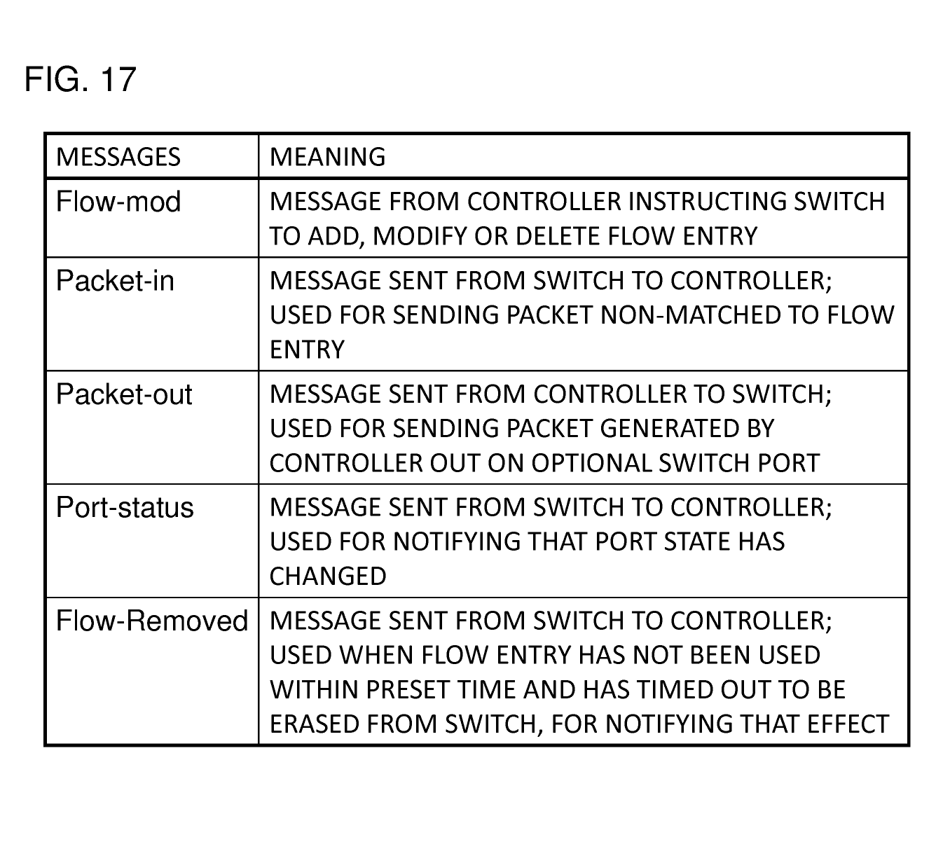

Referring to FIG. 12, if a notification that the port m is down is received from the switch S (step S21), the controller 6 transmits a control message (Flow-mod message of FIG. 17) to a switch S by way of instructing deleting the second control information from the second table Tm correlated with the port m of the switch S (step S22).

For example, if the notification that the port 2 is down is received from the switch 121 of FIG. 7, the controller 6 instructs the switch 121 to delete the entry of the high priority second control information from the upper side table T2 of FIG. 11. Thus, if subsequently the switch 121 should receive a packet addressed to the server 141, having the destination IP address of 192.168.1.1, the packet hits the first control information having 192.168.1.0/24 set as the match condition. Hence, an action stated in the first control information, that is, an action stating that the packet is to be output on the port 3, is applied. As a consequence, the path of the destination prefix 192.168.1.0/24, shown in FIG. 7, is changed over from a solid-line regular system path to a broken-line spare system path.

Similarly, if the notification that the port 4 is down is received from the switch 121 of FIG. 7, the controller 6 instructs the switch 121 to delete an entry of the high priority second control information from the lower side table T4 of FIG. 11. Thus, if subsequently the switch 121 should receive a packet addressed to the server 142, having a destination IP address of 192.168.2.1, the packet hits the first control information. Hence, an action stated in the first control information, that is, an action stating that the packet is to be output on the port 3, is applied. As a consequence, the path destined for the server 141 shown in FIG. 7 is changed over from a solid-line regular system path to a broken-line spare system path.

It should be noted that the match condition identifying the packet being controlled is stated in the first control information implementing the spare path. Consequently, should the regular system paths of both the switches 122 and 124 have failed, packets may be forwarded to respective correct destinations providing that the control information having proper match conditions is set in the switch 123.

The operation for the case where the controller 6 of the subject exemplary embodiment should receive the port-down notification from the switch has been shown above. A similar operation may be possible in case of a failure of a link connecting to a port. For example, a message meaning Keep-Alive may be periodically transmitted between neighboring switches, so that, if these messages are not delivered within a preset time, the operating state may be deemed to be a link-down state. The processing similar to that shown in FIG. 12 may then be carried out for a port connecting to the link.

Although a preferred exemplary embodiment of the present invention has been described above, the present invention is not to be restricted to this particular mode, such that further changes, substitutions or adjustments may be made within the range not departing from the basic technical concept of the invention. For example, the configurations of networks or elements, shown in the drawings, are given merely as illustrations to assist in the understanding of the present invention, which is not to be restricted to the configurations shown.

For example, in the above described exemplary embodiment, all fields of the match conditions of the second control information are wildcarded. It is however also possible to enter a condition(s) in a particular field(s) so as to preclude a particular packet(s), such as a packet(s) with a particular VLAN ID, from the packets processed.

In the above described exemplary embodiment, the regular system path is changed over to the spare system path or vice versa with the port down or link failure as a trigger. However, the scope of application of the present invention is not limited to the above described exemplary embodiment. Specifically, the present invention may be applied to changing over a path with congestion in a particular link(s) as a trigger, or at a preset timing.

In the above described exemplary embodiment, such a case has been shown where three switches are connected to a sole switch.

However, no limitations are to be imposed on the number of the switches. For example, even if a switch is arranged on an output side of the switches 122 to 124 of FIG. 6, high speed path switching may be accomplished by calculating the path in a similar manner and by setting the first and second control information on an input side switch. This input side switch may not be necessarily the switch 121 such that it is only sufficient if a switch has a port(s) enabling formulating an alternate path.

Finally, certain preferred modes of the present invention will be summarized.

### [Mode 1]

(See the controller according to the above mentioned first aspect).

### [Mode 2]

The controller according to mode 1, further comprising

a failure notification receiving unit that detects failure of the second path based on the information collected from the forwarding apparatus being controlled;

the forwarding control unit on occurrence of a failure on the second path instructing the forwarding apparatus being controlled to delete the second control information.

### [Mode 3]

The controller according to mode 1 or 2, wherein,

the forwarding control unit sets, in the forwarding apparatus being controlled, a first table that correlates a matching condition(s) for matching against a packet(s) received with a second table(s) to be referenced;

the forwarding control unit also setting, in the forwarding apparatus being controlled, a plurality of the second tables; each of the second tables storing the first control information and the second control information and being referenced in accordance with a designation by the first table.

### [Mode 4]

The controller according to mode 3, wherein;

the plurality of the second tables are provided in a one-to-one relationship to output ports of the forwarding apparatus.

### [Mode 5]

The controller according to any one of modes 1 to 4, wherein,

the first path is a spare path for a case of failure of the second path.

### [Mode 6]

(See the communication system according to the above mentioned second aspect).

### [Mode 7]

(See the path switching method according to the above mentioned third aspect).

### [Mode 8]

(See the program according to the above mentioned fourth aspect).

It should be noted that the above mentioned modes 6 to 8 may be extended to the modes 2 to 5, as is the mode 1.

The disclosures of the above mentioned Patent and Non-Patent Literatures are to be incorporated herein by reference. The exemplary embodiments or Examples may be modified or adjusted within the concept of the total disclosures of the present invention, inclusive of claims, based on the fundamental technical concept of the invention. A series of combinations or selections of elements herein disclosed (elements of claims, Examples and drawings) may be made within the context of the claims of the present invention. That is, the present invention may include a wide variety of changes or corrections that may occur to those skilled in the art in accordance with the total disclosures inclusive of the claims and the drawings as well as the technical concept of the invention. In particular, it should be understood that any optional numerical figures or sub-ranges contained in the ranges of numerical values set out herein ought to be construed to be specifically stated even in the absence of explicit statements.

### REFERENCE SIGNS LIST

1 secure channel
2 switch management unit
3 path management unit
4 topology management unit
5 path database (path DB)
6, 60 controllers
21 failure notification receiving unit
22 control information send-out unit
31 control information deletion command generation unit
32 path calculation unit
33 spare system path calculation unit
34 regular system control information generation unit
35 regular system second-table control information generation unit
36 spare system control information generation unit
41 topology update unit
42 topology DB
61 first control information generation unit
62 second control information generation unit
63 forwarding control unit
101 terminal
120 forwarding apparatus
121-124 switches
131, 132 networks
141, 142 servers
411 ID of an input side switch
412 output port number of the input side switch
413 ID of an output side switch
414 ingress port number of output side switch
511 destination prefix
512 ID of output switch
513 ID of output switch (spare)

What is claimed is:

1. A controller comprising:
a first control information generation unit that generates the first control information that causes a forwarding apparatus being controlled to forward a packet(s) over a first path;
a second control information generation unit that generates the second control information that causes the forwarding apparatus being controlled to forward a group of packets, inclusive of the packet as an object controlled by the first control information, over a second path different from the first path; and
a forwarding control unit that sets the priority level of the first control information and that of the second control information in the forwarding apparatus being controlled so that the priority level of the second control information will be higher than that of the first control information, and that, by instructing the forwarding apparatus being controlled to delete the second control information, changes over the forwarding path of at least the packet(s) matching the first control information.

2. The controller according to claim 1, further comprising
a failure notification receiving unit that detects failure of the second path based on the information collected from the forwarding apparatus being controlled;
the forwarding control unit on occurrence of a failure on the second path instructing the forwarding apparatus being controlled to delete the second control information.

3. The controller according to claim 1, wherein,
the forwarding control unit sets, in the forwarding apparatus being controlled, a first table that correlates a matching condition(s) for matching against a packet(s) received with a second table(s) to be referenced;
the forwarding control unit also setting, in the forwarding apparatus being controlled, a plurality of the second tables; each of the second tables storing the first control information and the second control information and being referenced in accordance with a designation by the first table.

4. The controller according to claim 3, wherein;
the plurality of the second tables are provided in a one-to-one relationship to output ports of the forwarding apparatus.

5. The controller according to claim 1, wherein,
the first path comprises a spare path for a case of failure of the second path.

6. A communication system comprising:
a forwarding apparatus that processes a packet received in accordance with the control information that is set from outside, and
a controller; the controller including
a first control information generation unit that generates the first control information that causes the forwarding apparatus to forward a packet(s) over a first path;
a second control information generation unit that generates the second control information that causes the forwarding apparatus to forward a group of packets, inclusive of the packet as an object controlled by the first control information, over a second path different from the first path; and
a forwarding control unit that sets the priority level of the first control information and that of the second control information in the forwarding apparatus so that the priority level of the second control information will be higher than that of the first control information, and that, by instructing the forwarding apparatus to delete the second control information, changes over the forwarding path of at least the packet(s) matching the first control information.

7. A method for path switching comprising-the steps of:
generating the first control information that causes a forwarding apparatus being controlled to forward a packet(s) over a first path;
generating the second control information that causes the forwarding apparatus being controlled to forward a group of packets, inclusive of the packet as an object controlled by the first control information, over a second path different from the first path;
setting the priority level of the first control information and that of the second control information in the forwarding apparatus being controlled so that the priority level of the second control information will be higher than that of the first control information; and
instructing the forwarding apparatus being controlled to delete the second control information to change over the forwarding path of at least the packet(s) matching the first control information.

8. A non-transitory computer-readable recording medium storing thereon a program that causes a computer configured to control a forwarding apparatus to perform:
a processing of generating the first control information that causes the forwarding apparatus being controlled to forward a packet(s) over a first path;
a processing of generating the second control information that causes the forwarding apparatus being controlled to forward a group of packets, inclusive of the packet as an object controlled by the first control information, over a second path different from the first path;
a processing of setting the priority level of the first control information and that of the second control information in the forwarding apparatus being controlled so that the priority level of the second control information will be higher than that of the first control information; and
a processing of instructing the forwarding apparatus being controlled to delete the second control information to change over the forwarding path of at least the packet(s) matching the first control information.

9. The controller according to claim 2, wherein,
the forwarding control unit sets, in the forwarding apparatus being controlled, a first table that correlates a matching condition(s) for matching against a packet(s) received with a second table(s) to be referenced;
the forwarding control unit also setting, in the forwarding apparatus being controlled, a plurality of the second tables; each of the second tables storing the first control information and the second control information and being referenced in accordance with a designation by the first table.

10. The controller according to claim 2, wherein,
the first path comprises a spare path for a case of failure of the second path.

11. The controller according to claim 3, wherein,
the first path comprises a spare path for a case of failure of the second path.

12. The controller according to claim 4, wherein,
the first path comprises a spare path for a case of failure of the second path.
